(19) United States
(12) Patent Application Publication
(10) Pub. No.: US 2019/0005547 A1
(43) Pub. Date: Jan. 3, 2019

(54) ADVERTISER PREDICTION SYSTEM

(71) Applicant: Facebook, Inc., Menlo Park, CA (US)

(72) Inventors: Li Tan, Fremont, CA (US); Honglu He, Santa Clara, CA (US); Kiranjit Singh Sidhu, East Palo Alto, CA (US); David Harry Garcia, Sunnyvale, CA (US); Jinchong Zhou, Fremont, CA (US); Zhi Zhong, Sunnyvale, CA (US); Jinyi Yao, Issaquah, WA (US); David Shein, San Francisco, CA (US); Nikila Srinivasan Sarang, San Francisco, CA (US); Yating Ma, Fremont, CA (US); Rui Shao, Mountain View, CA (US); Han Chen, London (GB); Hao Wang, London (GB); Ning Wang, Jersey City, NJ (US)

(21) Appl. No.: 15/803,562

(22) Filed: Nov. 3, 2017

Related U.S. Application Data
(60) Provisional application No. 62/527,581, filed on Jun. 30, 2017.

(51) Int. Cl. G06Q 30/02; G06F 15/18; G06F 17/30

(52) U.S. Cl. CPC G06Q 30/0271; G06Q 30/0257; G06Q 50/01; G06F 17/30029; G06F 17/3053; G06F 15/18

(57) ABSTRACT

Disclosed is a method for supporting online services in providing content items to users of an online system. A request for loading a webpage of an online system is received from a client device. A plurality of content items eligible for being presented to the user is received. For each of the received content items, a trained model is identified based on characteristics of the content item, and a score is determined using the identified trained model and based on characteristics of the user. One or more content items is selected based on the determined scores. The selected one or more content items are sent to the client device for presentation to the user.

### CROSS REFERENCE TO RELATED APPLICATIONS

This application claims the benefit of U.S. Provisional Application No. 62/527,581, filed Jun. 30, 2017, which is incorporated by reference in its entirety.

### BACKGROUND

### Field of the Disclosure

This disclosure relates generally to content item selection and more specifically to identifying content items for presentation to a user using a trained machine learning model and characteristics of the user.

### Description of the Related Art

Users go to online systems to consume content that interest them. For instance, some users go to a social networking system to view stories posted by their friends. In another example, users go to websites to view videos or read articles related to topics that interest them. In some instances, the content available for viewing by users is provided to the online system by content providers. Online systems may also show advertisements users based on characteristics of the user's profile.

Content providers and advertisers may additionally be provided with content that relate to their respective pages. For instance, a content provider may be interested in receiving content related to the performance of the contents the content provider provided to the online system. Furthermore, content provider may also be interested in content that helps the content provider improve their pages (e.g., how to increase user engagement). Similarly, advertisers may be interested in content related to the performance of the different advertisement campaigns the advertiser is running, or content related to the demographics of the users that show interest to the advertiser's advertisements.

Typically, this content is shown to users in a dashboard or with another defined layout where each piece of content is placed in a layout that is designed by a system administrator of the online system. In a dashboard, the different pieces of content are located in a pre-determined location which may increase familiarity, but as possible types of content that can be shown increase, the complexity of the dashboard also increases and may rely on manual modifications to the designed layout. Furthermore, users have different preferences on the content they would like to see or that they think is useful. For instance, a user that is new may find educational content about how the online system works very useful, while a more experienced user may find little value in such educational content. Moreover, in a dashboard, users may only interact with content that they are more familiar with and ignore other content. In some instances the content ignored by those users is helpful to them but these users may not realize the value of that content.

As such, there is a need for a system that customizes the content shown to users to include content that the users would find useful. Furthermore, there is a need for a system that increases the diversity of the content provided to the user to increase the likelihood of users interacting with the different types of content items.

### SUMMARY

An online system that empowers online services in providing content items to users who administer pages on the online system based on a score indicative of the likelihood the user will be interested in the content item. Different types of content items may be eligible for presentation to these users, such as content items to learn about page administration functions, to learn about promoting the page, statistical data, and so forth. The score indicative of the likelihood that the user will be interested in the content item is determined using a trained machine learning model for the type of content item and characteristics of the user. To ensure sufficient training data for the variety of content item types, the online system may employ an exploration strategy to allow content items with lower scores to be presented to users.

The online system also collects feedback regarding a level of interaction of the user with the content items presented to the users. For instance, feedback includes an indication whether a user clicked on a link associated with the content item, whether a user performed an action associated with the content item, or whether the user indicated the user is not interested in the content item. The online system the uses the collected feedback to train the machine learning model for calculating the score indicative of the likelihood that a user will be interested in a specific content item. For different content types and different users, these actions may be weighed differently to determine the relative score for each content type to a particular user.

In particular, disclosed is a method for supporting online services in providing content items to users of an online system. A request for loading a webpage of an online system is received from a client device. A determination is made whether a user of the client device is associated with a page in the online system, the page having content available for viewing by other users of the online system. If the user is associated with a page, a plurality of content items eligible for being presented to the user is received. The received content items, for example, provides suggestions to the user on how to improve the user's page, what content to provide to the online system to increase user engagement with the user's page, or information about the performance of the page or the content provided by the user to the online system. For each of the received content items, a trained model is identified based on characteristics of the content item, and a score is determined using the identified trained model and based on characteristics of the user. One or more content items is selected based on the determined scores. The selected one or more content items are sent to the client device for presentation to the user.

### BRIEF DESCRIPTION OF THE DRAWINGS

FIG. 1 is a block diagram of a system environment in which an online system operates, in accordance with an embodiment.

FIG. 2A is a block diagram of an online system, in accordance with an embodiment.

FIG. 2B is a block diagram of the content selection module, in accordance with an embodiment.

FIG. 3 is a flow diagram of a method for providing content items to a user of an online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

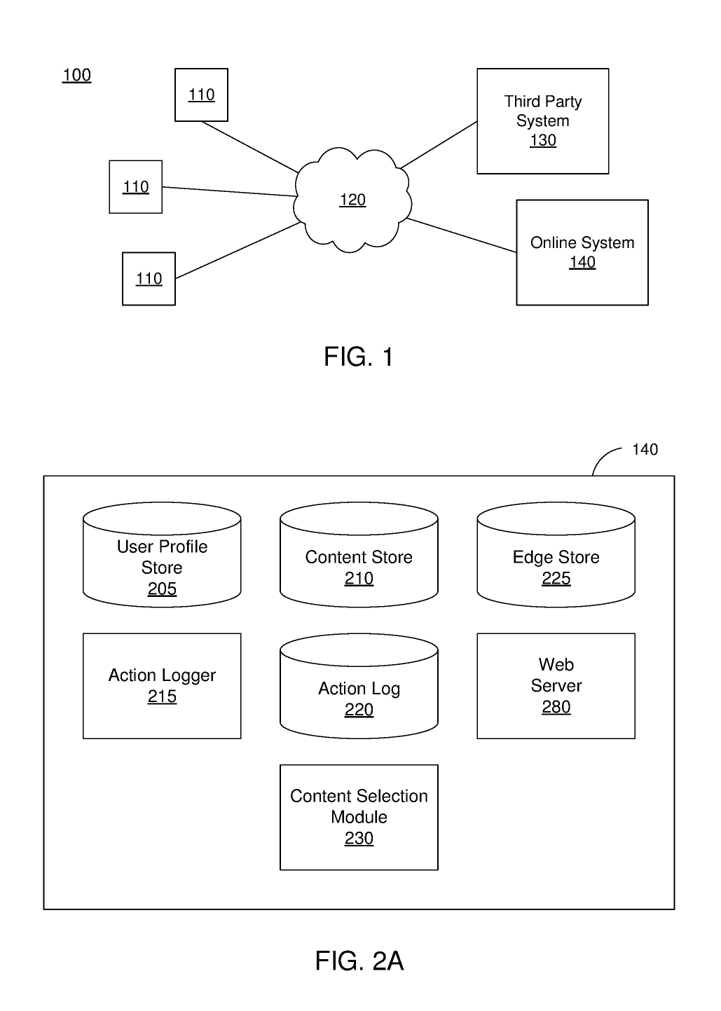

FIG. 1 is a block diagram of a system environment 100 for an online system 140, in accordance with one embodiment. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

### Online System

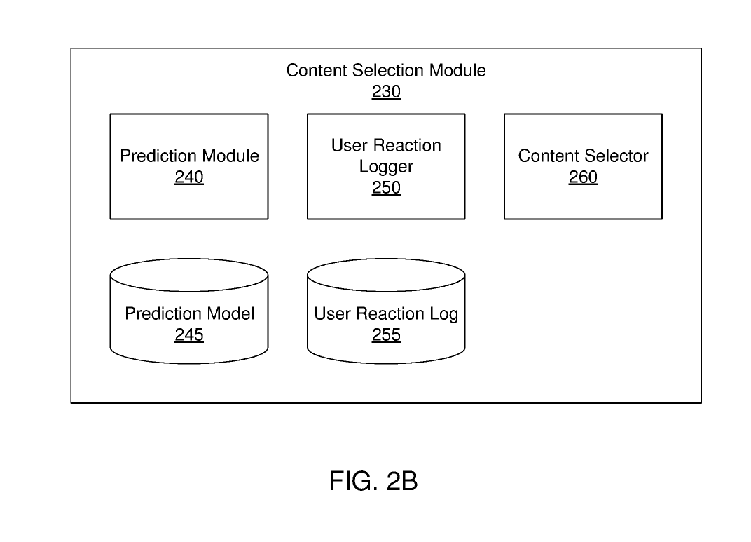

FIG. 2A is a block diagram of an architecture of the online system 140. The online system 140 shown in FIG. 2A includes a user profile store 205, a content store 210, an action logger 215, an action log 220, an edge store 225, a content selection module 230, and a web server 280. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups, or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile, and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate, or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects content for presentation to a user of the online system 140. FIG. 2B illustrates a block diagram of the content selection module 230, in accordance with one embodiment. The content selection module 230 includes a prediction module 240, a prediction model 245, a user reaction logger 250, a user reaction log 255, and a content selector 260.

In some embodiments, the content selection module 230 selects content for users that are associated with a page in the online system 140. The content selected by the content selection module includes content growth products that help the user improve the user's page. For instance, the content that the content selection module 230 selects includes content items that suggests the user what stories to post to increase user engagement. In one embodiment, the content selection module 230 selects content items for advertisers that provide advertisements in the online system. In this embodiment, the content selection module 230 selects content items that help the advertiser manage the various advertisement campaigns associated with a page of the advertiser. The content selection module 230 may additionally select content items that help the user improve the page the user is associated with.

The prediction module 240 receives multiple content items that a user is eligible to receive and generates a score for each of the received content items. For instance the prediction module 240 receives a first content item to persuade a user to create a story based on a picture the user recently posted, a second content item to suggest the user to update a profile picture, and a third content item to inform the user how many other users of the online system have interacted with a story the user previously created. The prediction module 240 then generates a score for each of the received content items using a prediction model 245.

As part of the generation of the prediction model 245, the prediction module 240 forms a training set of content item impressions by identifying a positive training set of content item impressions that have been determined to have the property in question (e.g., content items that a user has shown interest in, content items that resulted in a conversion, or content items that a user has interacted with), and, in some embodiments, forms a negative training set of content item impressions that lack the property in question (e.g., content items that a user has X-out of, content items that did not result in a conversion for a user, or content items that a user has not interacted with).

The prediction model 245 is trained based on feedback received from the user for content items that were presented to the user in the past. The positive training set includes content item impressions to users where the user provided a specific type of interaction. For instance, positive training samples for certain types of content items include content items for which the user clicked a link associated with the content item, or the user performed an action (e.g., purchasing a specific item or updating a profile picture associated with the user's account) associated with the content item.

The negative training set includes content item impressions to users where the user provided feedback indicating that the user is not interested in the content item. For instance, negative training samples include content items that a user has X-out from, or content items a user has ignored.

The prediction module 240 extracts feature values from the content item impressions of the training set, the features being variables deemed potentially relevant to whether or not the content item impressions have the associated property or properties. Specifically, the feature values extracted by the prediction module 240 include information regarding the user to which the content item impression was sent to, information regarding the content item associated with the impression, and a time and date the content item impression was sent to the user. An ordered list of the features for a content item is herein referred to as the feature vector for the content item. In one embodiment, the prediction module 240 applies dimensionality reduction (e.g., via linear discriminant analysis (LDA), principle component analysis (PCA), or the like) to reduce the amount of data in the feature vectors to a smaller, more representative set of data.

The prediction module 240 uses supervised machine learning to train the prediction model 245, with the feature vectors of the positive training set and the negative training set serving as the inputs. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments. The prediction model 245, when applied to the feature vector extracted from a potential content item impression, outputs an indication of whether the content item impression has the property in question, such as a Boolean yes/no estimate, or a scalar value representing a probability.

In some embodiments, the scores for a content item is determined based on the click-through rate (CTR), a conversion rate (CVR), and an X-out rate (XTR). In particular the score is determined based on a machine learned probability that a user will click an add given a content item impression (eCTR), a probability that a user will perform an action given a content item impression (eCVR), and a probability that a user will choose to X-out of a content item given a content item impression (eXTR) are user. For instance, the score is determined as:

Score=w₁·eCVR+w₂·eCTR−eXTR

where w₁ and w₂ are weights for balancing different objectives across clicks, conversions, and X-outs. Different weights w₁ and w₂ may be determined for each type of content. In some embodiments, the weights w₁ and w₂ for a specific type of content are determined based on historical information for users that were presented with a content item having the specific type. For instance, for users that were previously presented with a content item having the specific type, a eCTR and a eCVR are determined. Based on the determined eCTR and eCVR information, a eCTR and a eCVR distribution is generated based on a frequency of users having specific eCTR and eCVR values. Using the generated distributions, eCTR and eCVR values are identified for preset percentiles of the respective distributions. In some embodiments, eCTR and eCVR values for a low preset percentile and a high preset percentile is determined. For example, eCTR and eCVR values for the 5^{th} percentile and the 95^{th} percentile of the eCTR and eCVR distributions are determined. In one embodiment, for a specific type of content, the eCVR distribution is generated based on users that have previously converted when a content item having the specific type was presented. Additionally, for the specific type of content, the eCTR distribution is generated based on users that have not previously converted when a content item having the specific type was presented. The weight w₁ is then determined so that:

w₁·eCVR(low %)>eCTR(high %)

where eCVR(low %) is the eCVR value for the low preset percentile of the eCVR distribution (e.g., the 5^{th} percentile value of the eCVR distribution) and eCTR(high %) is the high preset percentile of the eCTR distribution (e.g., the 95^{th} percentile value of the eCTR distribution). The weight w₂ may be determined in a similar manner.

In some embodiments, eCTR, eCVR, and eXTR are determined for each type of content and are based on characteristics of the user and the context in which the content items were presented to the users. Characteristics of the user includes a level of experience of the user, a frequency the user visits the online system, and size of the user's page. Context in which content items are presented to users include time of the date the content items are presented to the user, location in which the content item was placed when presented to the user, and other content that was concurrently presented to the user when the content item was presented to the user.

In some embodiments, a different prediction model 245 is generated for different types of content items. For instance, a prediction model 245 is generated for educational content items, advertisement content items, and stories. The prediction model 245 for each of the content types may use different input signals. For instance, a prediction model for educational content uses as inputs a user's age, a frequency the user updates their profile, and a frequency the user accesses the online system. In another example, a prediction model for advertisement content uses as inputs a user's demographics information and a frequency of advertisement conversions by the user.

When a new type of content item is created for presentation to eligible users, the prediction module 240 generates a new model for the newly created type of content item, and updates the model as new interaction information is received.

In some embodiments, multiple prediction models 245 are generated for each of the different types of content items. For instance, ten different prediction models, each using a different set of inputs, are generated for education content items. Among all the prediction models for a specific type of content item, a single prediction model is selected for being used during the scoring of the content items. In some embodiments, a system administrator of the online system selects the prediction model to be used for scoring content items. In other embodiments, the content selection module 230 selects a prediction model based on feedback received by the online system regarding the performance of each of the content items. That is, the content selection module 230 may use each of the prediction models to generate a score for a set of content items and select the prediction model that generates the score that most closely relates to the frequency of engagement of users to the set of content items.

In some embodiments, the content selection module 230 selects content for presentation to content providers of the online system. Content that is selected by the content selection module 230 includes suggestions on what content the content provider should post in the online system to increase user engagement, which content the content provider should promote, statistics about the user engagement with the content posted by the content provider, and educational content regarding how to improve the content provider's page within the online system.

The content selector 260 selects one or more content items to be presented to a user of the online system based on the scores generated by the prediction module 240. In some embodiments, the content selector 260 selects a set number of content items that have a highest score as determined by the prediction module 240. In other embodiments, selects content items using a randomizing algorithm. The randomizing algorithm may use the scores generated by the prediction module 240 to assign a likelihood for the content story to be selected. For instance, the highest ranked content item is be assigned a 50% likelihood of being selected, the second highest ranked content item is assigned a 30% likelihood of being selected, and the third highest ranked content item is assigned a 20% likelihood of being selected. In some embodiments, every content item is assigned a non-zero likelihood of being selected. This increases the probability of certain content items being selected and improves the diversity of content items being displayed to the user.

The user reaction logger 250 receives feedback based on an action taken by a user to a content item presented. The user reaction logger 250 stores the received feedback in the user reaction log 255. The feedback received by the user reaction logger 250 may include an indication that a user clicked a content item, whether a user X-out the content item, and whether the user ignored the content item. The prediction module 240 then uses the feedback stored in the user reaction logger to train the prediction model 245.

The web server 280 links the online system 140 via the network 120 to the one or more client devices 110, as well as to the one or more third party systems 130. The web server 280 serves web pages, as well as other content, such as JAVA®, FLASH®, XML, and so forth. The web server 280 may receive and route messages between the online system 140 and the client device 110, for example, instant messages, queued messages (e.g., email), text messages, short message service (SMS) messages, or messages sent using any other suitable messaging technique. A user may send a request to the web server 280 to upload information (e.g., images or videos) that are stored in the content store 210. Additionally, the web server 280 may provide application programming interface (API) functionality to send data directly to native client device operating systems, such as IOS®, ANDROID™, or BlackberryOS.

### Content Selection System

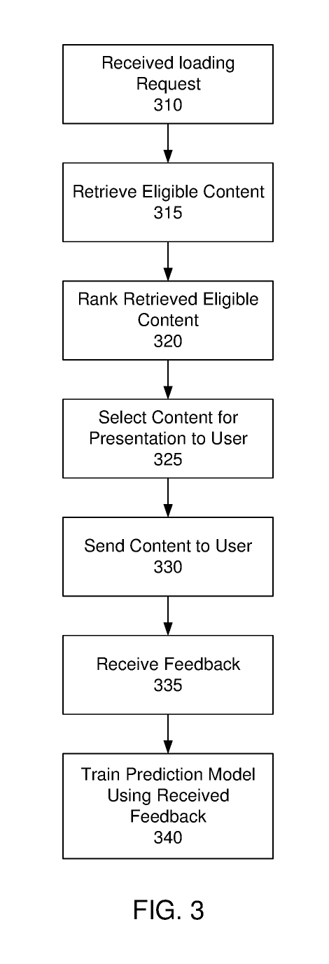

FIG. 3 illustrates a flow diagram of a process for selecting content items for presentation to a user of an online system 140. In some embodiments, the process illustrated in the flow diagram of FIG. 3 is performed for selecting content that is specific for users that are associated with a page of the online system. In particular, users that are an administrator of a page, or have administrative privileges. Example of those users include advertisers that own a page in the online system where stories (e.g., advertisers) associated with products the user is trying to advertise are posted in the user's page. Another example includes content creators (e.g., video creators) that provide stories to the online system for viewing by any other user of the online system.

The online system 140 receives 310 a request for loading a webpage. For instance, a user access a URL associated with the online system using a browser on a client device. In some embodiments, the user is logged in to the online system. That is, the user has provided user credentials, such as, username and password, to the online system.

To fulfill the loading request, the online system 140 retrieves 315 content from the content store 210 that is eligible for presentation to the user. In one embodiment, the online system 140 determines whether the user is associated with a page in the online system 140. For example, the online system 140 determines if the user is an administrator of a page of the online system 140. If the user is associated with a page, the online system may retrieve content items that provides suggestions to the user on how to improve the user's page. For example, a content item suggests the user to update a profile picture associated with the page. In another embodiment, the online system 140 determines whether the user has recently uploaded a picture of video to the online system 140. If the user has uploaded a picture or video, a content item may suggest the user to use the recently uploaded picture or video to create new story for the user's page. In yet another embodiment, the content item suggests the user to promote a story associated with user or the user's page.

The prediction module 240 ranks 320 the retrieved content using the prediction model 245. To rank the retrieved content, the prediction module 240 uses the prediction model 245 to generate a score for each of the retrieved content. The generated score may be indicative of the likelihood of the user from interacting with content item.

The content selector 260 selects 325 one or more content items for presentation to the user and the selected content items are sent 330 to a client device of the user. The client device of the user displays the content items. The online system 140 receives 335 feedback regarding the interaction from the user with the content items. For instance, the online system 140 receives an indication whether the user clicked the content item or X-out of the content item. The online system may also receive an indication whether the user has performed an action described in the content item within a predetermined amount of time. For example, the content item may suggest a user to update their profile picture. If the user changes their profile picture within 30 minutes of receiving the content item, the change of the profile picture by the user is attributed to the content item. That is, the content item is said to have generated a conversion.

The prediction module 240 trains or updates 340 the prediction model 245 based on the received feedback. The prediction module 240 use positive feedback (e.g., an interaction by the user with a content item, or a content item conversion) as a positive sample for training the prediction model 245. The prediction module 240 uses negative feedback (e.g., an X-out of the content item by the user) as a negative sample for training the prediction model 245. In some embodiments, the prediction module 240 uses content item impression for which feedback is not received as negative a negative sample for training the feedback model 245. For instance, if a content item is sent and presented to a user and the user does not interact with the content item or performs an action described in the content item, the content item impression is used as a negative training sample since the lack of interaction may imply a lack of interest of the user on the content item. The prediction module 240 may weigh a lack of feedback differently than an explicit negative feedback. Alternatively, the prediction module 240 may consider a lack of interaction for a set number of impressions (e.g., 1000 impressions) for a specific content item as a single negative feedback. That is, if a content item is sent to one or more users a large number of times, and the content item is ignored by the one or more users 1000 times, this is event is consider by the prediction module 240 as a single negative feedback sample for training the prediction model 245.

After the prediction model 245 is updated based on new feedback data, the updated prediction model 245 is used for ranking eligible content of subsequent loading requests received by the online system 140. In some embodiments, the prediction model 245 is updated periodically. For example, the prediction model 245 is updated weekly with the new feedback data received throughout the week.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a request, from a client device, for loading a webpage of an online system, the request including an identification of a user of the online system;
receiving a plurality of content items eligible for being presented to the user, the user associated with a page in the online system, the page having content available for viewing by other users of the online system;
for each of the content items:
identifying a trained model based at least in part on a type of the content item,
determining a score for the content item using the identified trained model, and based at least in part on characteristics of the user;
selecting one or more content item based on the determined scores; and
sending the selected one or more content items to the client device for presentation to user.

2. The method of claim 1, further comprising:
receiving feedback from the client device regarding an interaction of the user with a first content item sent for presentation to the user;
identifying a trained model based at least in part on a type of the first content item; and
updating the trained model based on the received feedback.

3. The method of claim 2, wherein the feedback is one of the user clicking a link associated with the first content item, the user performing an action associated with the content item within a set time period, and the user indicating that the user is not interested in the first content item.

4. The method of claim 1, wherein selecting one or more content item based on the determined scores comprises:
selecting a set number of content items with a highest determined score.

5. The method of claim 1, wherein selecting one or more content items based on the determined scores comprises:
ranking the content items based on the determined scores; and
determining whether to send a content item based on a randomizing function and a ranking of the content item.

6. The method of claim 1, wherein the plurality of content items eligible for being presented to the user comprises at least on of:
suggestions on what content the content provider should post in the online system to increase user engagement,
which content the content provider should promote,
statistics about the user engagement with the content posted by the content provider, and
educational content regarding how to improve the content provider's page within the online system.

7. The method of claim 1, wherein receiving a plurality of content items eligible for being presented to the user comprises:
determining whether the user is associated with a page of the online system; and
responsive to determining that the user is associated with a page of the online system, identifying content for presentation to the user based on characteristics of the page associated with the user

8. A non-transitory computer readable medium storing instructions that when executed by a processor, cause the processor to:
receive a request, from a client device, for loading a webpage of an online system, the request including an identification of a user of the online system;
receive a plurality of content items eligible for being presented to the user, the user associated with a page in the online system, the page having content available for viewing by other users of the online system;
for each of the content items:
identify a trained model based at least in part on a type of the content item,
determine a score for the content item using the identified trained model, and based at least in part on characteristics of the user;
select one or more content item based on the determined scores; and
send the selected one or more content items to the client device for presentation to user.

9. The non-transitory computer readable medium of claim 8, further comprising:
receive feedback from the client device regarding an interaction of the user with a first content item sent for presentation to the user;
identify a trained model based at least in part on a type of the first content item; and
update the trained model based on the received feedback.

10. The non-transitory computer readable medium of claim 9, wherein the feedback is one of the user clicking a link associated with the first content item, the user performing an action associated with the content item within a set time period, and the user indicating that the user is not interested in the first content item.

11. The non-transitory computer readable medium of claim 8, wherein selecting one or more content item based on the determined scores comprises:
select a set number of content items with a highest determined score.

12. The non-transitory computer readable medium of claim 8, wherein selecting one or more content items based on the determined scores comprises:
rank the content items based on the determined scores; and
determine whether to send a content item based on a randomizing function and a ranking of the content item.

13. The non-transitory computer readable medium of claim 8, wherein the plurality of content items eligible for being presented to the user comprises at least on of:
suggestions on what content the content provider should post in the online system to increase user engagement,
which content the content provider should promote,
statistics about the user engagement with the content posted by the content provider, and
educational content regarding how to improve the content provider's page within the online system.

14. The non-transitory computer readable medium of claim 8, wherein receiving a plurality of content items eligible for being presented to the user comprises:
determine whether the user is associated with a page of the online system; and
responsive to determining that the user is associated with a page of the online system, identify content for presentation to the user based on characteristics of the page associated with the user.

15. A system comprising:
a processor; and
a non-transitory computer readable medium storing instructions that when executed by the processor, cause the processor to:
receive a request, from a client device, for loading a webpage of an online system, the request including an identification of a user of the online system;
receive a plurality of content items eligible for being presented to the user, the user associated with a page in the online system, the page having content available for viewing by other users of the online system;
for each of the content items:
identify a trained model based at least in part on a type of the content item,
determine a score for the content item using the identified trained model, and based at least in part on characteristics of the user;
select one or more content item based on the determined scores; and
send the selected one or more content items to the client device for presentation to user.

16. The system of claim 15, wherein the instructions further cause the processor to:
receive feedback from the client device regarding an interaction of the user with a first content item sent for presentation to the user;
identify a trained model based at least in part on a type of the first content item; and
update the trained model based on the received feedback.

17. The system of claim 16, wherein the feedback is one of the user clicking a link associated with the first content item, the user performing an action associated with the content item within a set time period, and the user indicating that the user is not interested in the first content item.

18. The system of claim 15, wherein the instructions for selecting one or more content item based on the determined scores cause the processor to:
select a set number of content items with a highest determined score.

19. The system of claim 15, wherein the instructions for selecting one or more content items based on the determined scores cause the processor to:
rank the content items based on the determined scores; and
determine whether to send a content item based on a randomizing function and a ranking of the content item.

20. The system of claim 15, wherein the plurality of content items eligible for being presented to the user comprises at least on of:
suggestions on what content the content provider should post in the online system to increase user engagement,
which content the content provider should promote,
statistics about the user engagement with the content posted by the content provider, and
educational content regarding how to improve the content provider's page within the online system.
